(19) United States
(12) Patent Application Publication
(10) Pub. No.: US 2025/0147215 A1
(43) Pub. Date: May 8, 2025

(54) WIRE GRID POLARIZER WITH PROTECTIVE CAP

(71) Applicant: Moxtek, Inc., Orem, UT (US)

(72) Inventors: Rumyana V. PETROVA, Pleasant Grove, UT (US); R. Stewart NIELSON, Pleasant Grove, UT (US); Michael BLACK, Orem, UT (US)

(21) Appl. No.: 19/014,516

(22) Filed: Jan. 9, 2025

Related U.S. Application Data
(63) Continuation of application No. 17/730,349, filed on Apr. 27, 2022, now Pat. No. 12,242,094.
(60) Provisional application No. 63/193,713, filed on May 27, 2021.

(51) Int. Cl. G02B 5/30; G02B 1/04

(52) U.S. Cl. CPC G02B 5/3058; G02B 1/04

(57) ABSTRACT

Each wire 12 of a wire grid polarizer can include a cap 22 on a reflective rib 21. The cap 22, with dimensions and material as specified herein, can protect the reflective rib 21 from corrosion and can improve performance of the wire grid polarizer. The cap 22 can be located on the distal end 21_{d} and the pair of sidewalls 21_{S} of the reflective rib 21. Cap 22 chemistry can include CO, C═O, COO, aluminum fluoride, and aluminum oxide. Each cap 22 can have a maximum thickness Th_{CS} on the sidewall 21_{S} of the reflective rib 21 in an upper 50% (above plane 31) of the wire 12 farthest from the substrate 11. Each cap 22 can have a maximum thickness Th_{CS} on the sidewall 21_{S} that is greater than a maximum thickness Th_{CD} of the cap 22 on the distal end 21_{d}.

### CLAIM OF PRIORITY

This is a continuation of U.S. patent application Ser. No. 17/730,349, filed Apr. 27, 2022; which claims priority to U.S. Provisional Patent Application No. 63/193,713, filed on May 27, 2021; which are hereby incorporated herein by reference.

### FIELD OF THE INVENTION

The present application is related to wire grid polarizers.

### BACKGROUND

A wire grid polarizer can divide light into two different polarization states. One polarization state can primarily pass through the wire grid polarizer. The other polarization state can be primarily absorbed or reflected. The effectiveness or performance of wire grid polarizers is based on high transmission of a predominantly-transmitted polarization (sometimes called Tp) and minimal transmission of an opposite polarization (sometimes called Ts).

It can be beneficial to have high contrast (Tp/Ts). Contrast can be improved by increasing transmission of the predominantly-transmitted polarization (e.g. increasing Tp) and by decreasing transmission of the opposite polarization (e.g. decreasing Ts).

Wires of wire grid polarizers, especially for polarization of visible or ultraviolet light, can be small and delicate with nanometer-sized pitch, wire-width, and wire-height. Wire grid polarizers are used in systems (e.g. computer projectors, semiconductor inspection tools, etc.) that require high performance. Corroded wires can significantly degrade system performance (e.g. distorted image from a computer projector). Therefore, it can be useful to protect the wires from corrosion.

### BRIEF DESCRIPTION OF THE DRAWINGS (DRAWINGS MIGHT NOT BE DRAWN TO SCALE)

FIG. 1 is a perspective-view of a wire grid polarizer 10 with an array of wires 12 on a substrate 11 with a channel between each pair of adjacent wires 12.

FIG. 2 is a cross-sectional side-view of a wire grid polarizer 20. Each wire 12 includes a cap 22 on a reflective rib 21.

FIG. 3 is a cross-sectional side-view of a wire grid polarizer 30, showing dimensions of a maximum width W_{R} of the reflective rib 21, a maximum thickness Th_{CS} of the cap 22 on the sidewall 21_{S}, and a maximum thickness Th_{CD} of the cap 22 on the distal end 21_{d}.

FIG. 4 is a cross-sectional side-view of a wire grid polarizer 40. Each wire 12 is located on a substrate rib 11_{R}.

FIG. 5 is a cross-sectional side-view illustrating a step in a method of making a wire grid polarizer, including applying a polarizing-layer 52 to a surface of a substrate 11.

FIG. 6 is a cross-sectional side-view illustrating a step in a method of making a wire grid polarizer, including applying a mask-layer 62 on the polarizing-layer 52.

FIG. 7 is a cross-sectional side-view illustrating a step in a method of making a wire grid polarizer, including forming a grid pattern 72 in the mask-layer 62.

### DEFINITIONS

The following definitions, including plurals of the same, apply throughout this patent application.

As used herein, the term “elongated” means that wire length L is substantially greater than wire width W₁₂ and wire thickness Th₁₂. For example, wire length L can be ≥10 times, ≥100 times, ≥1000 times, or ≥10,000 times larger than wire width W₁₂, wire thickness Th₁₂, or both. See FIG. 1.

As used herein, the terms “on”, “located on”, “located at”, and “located over” mean located directly on or located over with some other solid material between. The terms “located directly on”, “adjoin”, “adjoins”, and “adjoining” mean direct and immediate contact.

Materials used in optical structures can absorb some light, reflect some light, and transmit some light. The following definitions distinguish between materials that are primarily absorptive, primarily reflective, or primarily transparent. Each material can be considered to be absorptive, reflective, or transparent in a wavelength range of intended use, across the ultraviolet spectrum, across the visible spectrum, across the infrared spectrum, or combinations thereof, and can have a different property in a different wavelength range. Materials are divided into absorptive, reflective, and transparent based on reflectance R, the real part of the refractive index n, and the imaginary part of the refractive index/extinction coefficient k. Equation 1 is used to determine the reflectance R of the interface between air and a uniform slab of the material at normal incidence:

$$R = \frac{{( n - 1 )}^{2} + {k}^{2}}{{( n + 1 )}^{2} + {k}^{2}} \qquad Equation l$$

Unless explicitly specified otherwise herein, materials with k≤0.1 in the wavelength range are “transparent” materials, materials with k>0.1 and R≤0.6 in the specified wavelength range are “absorptive” materials, and materials with k>0.1 and R>0.6 in the specified wavelength range are “reflective” materials. If explicitly so stated in the claims, materials with k>0.1 and R≥0.7, R≥0.8, or R>0.9, in the specified wavelength range, are “reflective” materials.

### DETAILED DESCRIPTION

As illustrated in FIGS. 1-4, wire grid polarizers 10, 20, 30, and 40 can include an array of wires 12 on a substrate 11 with a channel 13 between each pair of adjacent wires 12. The array of wires 12 can be parallel and elongated. A pitch P of the wires 12 can be less than ½ of a lowest wavelength of a desired range of polarization (e.g. P<200 nm for polarization of visible light). The channels 13 can be filled with air or other gas, vacuum, liquid, solid, or combinations thereof. Any solid in the channels 13 can be transparent. The substrate 11 can be transparent.

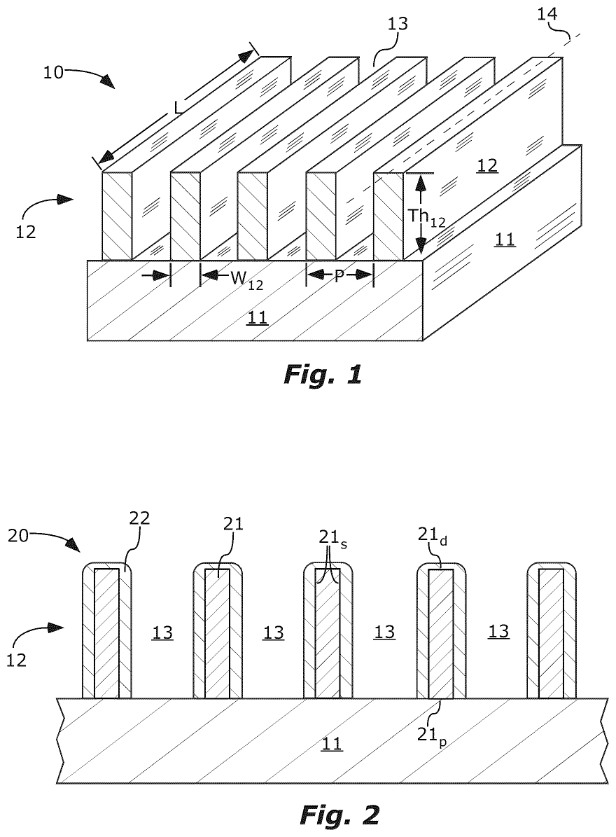

As illustrated on wire grid polarizers 20, 30, and 40 in FIGS. 2-4, each wire 12 can include a cap 22 on a reflective rib 21. The cap 22, with dimensions and material as specified herein, can protect the reflective rib 21 from corrosion and can improve performance of the wire grid polarizer 20, 30, or 40.

Each reflective rib 21 can have a distal end 21_{d} farthest from the substrate 11, a proximal end 21ₚ closest to the substrate 11, and a pair of sidewalls 21_{S}. Each sidewall 21_{S} can face a channel 13 and can extend from the distal end 21_{d} to the proximal end 21ₚ. Each cap 22 can be located on the distal end 21_{d} and the pair of sidewalls 21_{S} of one of the reflective ribs 21.

Each cap 22 can be separated from caps 22 of adjacent wires 12 by the channels 13. Thus, a face of the substrate 11 at a center of the channels 13 can be free of material of the caps 22.

The cap 22 can completely cover the distal end 21_{d} of the reflective rib 21.

It is preferable for protection of the reflective rib 21 that the cap 22 covers all of the sidewalls 21_{S} of the reflective rib 21. But it is difficult to achieve complete coverage of the sidewalls 21_{S} without connection of caps 22 across the channel 13. For example, the cap 22 can cover ≥50%, ≥70%, ≥90%, ≥95%, or all of the sidewalls 21_{S}. The cap 22 can be formed as the reflective ribs 21 and the substrate ribs 11_{R} are formed. Formation of the substrate ribs 11_{R} can increase cap 22 coverage of the sidewalls 21_{S}.

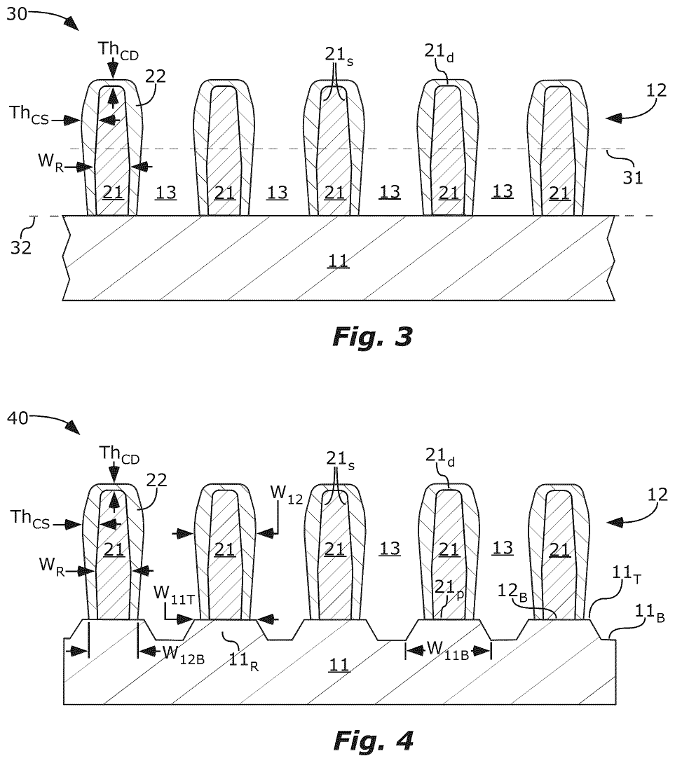

As illustrated in FIG. 3, each reflective rib 21 can have a maximum width W_{R} in a lower 50% (below plane 31) of the wire 12 closest to the substrate 11. This can reduce toppling of the wires 12. Increased use of hydrogen bromide in the etch, overetching the wires 12 (i.e. continued etch after reaching the substrate 11), medium to high radio frequency power, and low to medium bias voltage can produce wires 12 with this shape.

Each cap 22 can have a maximum thickness Th_{CS} on the sidewall 21_{S} of the reflective rib 21 in an upper 50% (above plane 31) of the wire 12 farthest from the substrate 11. Thus, the cap 22 can provide increased protection near the distal end 21_{d} where there is a greater risk of corrosion. Increased use of hydrogen bromide in the etch and reduced etching of the mask can produce caps 22 with this shape.

A ratio of the maximum width W_{R} of the reflective rib 21 to the maximum thickness Th_{CS} of the cap 22 on the sidewall 21_{S} can be selected for optimal wire grid polarizer performance and reflective rib 21 protection. For example, 0.5≤W_{R}/Th_{CS}, 1≤W_{R}/Th_{CS}, or 1.5≤W_{R}/Th_{CS}. Other examples include W_{R}/Th_{CS}≤1.5, W_{R}/Th_{CS}≤3, or W_{R}/Th_{CS}≤10. The maximum width W_{R} and the maximum thickness Th_{C} can both be measured on a single wire. The maximum width W_{R} and the maximum thickness Th_{C} can be measured perpendicular to a longitudinal axis 14 of the wire 12 (see longitudinal axis 14 in FIG. 1) and parallel to a plane 32 at the proximal end 21ₚ of the reflective ribs 21.

Each cap 22 can have a maximum thickness Th_{CS} on the sidewall 21_{S} that is greater than a maximum thickness Th_{CD} of the cap 22 on the distal end 21_{d}. This can increase transmission of a predominantly-transmitted polarization (e.g. increase Tp), and thus improve polarizer performance. Thus, for example, a minimum of Th_{CS}/Th_{CD} can be in the following range: 1.2≤Th_{CS}/Th_{CD}, 1.5≤ Th_{CS}/Th_{CD}, 2≤Th_{CS}/Th_{CD}, or 3≤Th_{CS}/Th_{C}. Some thickness Th_{CD} of the cap 22 is useful for protection of the distal end 21 the reflective rib 21. Thus, a maximum of Th_{CS}/Th_{CD} can be in the following range: Th_{CS}/Th_{CD}≤2.5, Th_{CS}/Th_{CD}≤3, Th_{CS}/Th_{CD}≤4, Th_{CS}/Th_{CD}≤6, or Th_{CS}/Th_{CD}≤10. Use of an anisotropic etch at the end of the etch can produce caps 22 with this shape.

Both of the maximum thicknesses Th_{CS} and Th_{CD} are measured on a single wire 12 and measured perpendicular to a longitudinal axis 14 of the wire 12 (see longitudinal axis 14 in FIG. 1). The maximum thickness Th_{CS} of the cap 22 on the sidewall 21_{S} is measured parallel to a plane 32 at the proximal end 21ₚ of the reflective ribs 21. The maximum thickness Th_{CD} of the cap 22 on the distal end 21_{d} is measured perpendicular to the plane 32 at the proximal end 21ₚ of the reflective ribs 21.

As illustrated in FIG. 4, each wire 12 can be located on a substrate rib 11_{R}. Each substrate rib 11_{R} can be integral with the substrate 11. The substrate rib 11_{R} can have a shape and size for improved wire grid polarizer performance, improved formation of the cap 22, or both, as will be explained in the following paragraph.

Each substrate rib 11_{R} can have a base 11 adjoining the substrate 11 and a top 11_{T} adjoining a bottom 12_{B} of the wire 12. A width W_{11T} of the bottom 11_{B} of the substrate rib 11_{R} can be greater than a width W_{12B} of the top 11_{T} of the substrate rib 11_{R} (W_{11B}>W_{11T}). This relationship can improve wire grid polarizer performance. Decreased use of carbon tetrafluoride in the etch, low radio frequency power, and high pressure can produce substrate ribs 11_{R} with this shape.

For example, W_{11B}/W_{11T}≥1.05, W_{11B}/W_{11T}≥1.1, or W_{11B}/W_{11T}≥1.2. Other examples include W_{11B}/W_{11T}≤1.3, W_{11B}/W_{11T}≤1.5, or W_{11B}/W_{11T}≤1.8. W_{11B} and W_{11T} are measured perpendicular to a longitudinal axis 14 of the wires 12 and parallel to a plane 32 at the proximal end 21ₚ of the reflective ribs 21.

A width W_{11T} of the top 11_{T} of the substrate rib 11_{R} can be greater than a width W_{12B} of the bottom 12_{B} of the wire 12 (W_{11T}>W_{12B}). A relationship between dimensions of the substrate rib 11_{R} and the wire 12 can be selected for improved wire grid polarizer performance, improved formation of the cap 22, or both.

For example, W_{11T}/W_{12B}≥1.05, W_{11T}/W_{12B}≥1.2, or W_{11T}/W_{12B}≥1.4. Other examples include W_{11T}/W_{12B}≤1.4, W_{11T}/W_{12B}≤1.6, W_{11T}/W_{12B}≤1.8, or W_{11T}/W_{12B}≤2. W_{11T} and W_{12B} are measured perpendicular to a longitudinal axis 14 of the wires 12 and parallel to a plane 32 at the proximal end 21ₚ of the reflective ribs 21. Forming the cap 22 with a maximum thickness Th_{CS} in an upper 50% (above plane 31) of the wire 12 can shield a top of the substrate rib 11_{R}, allowing formation of this shape.

A width W_{11T} of the top 11_{T} of the substrate rib 11_{R} can be about the same as a maximum width W₁₂ of the wire 12 (W_{11T}≈W₁₂). For example, 0.7≤ W₁₂/W_{11T}, 0.85≤W₁₂/W_{11T}, or 1≤W₁₂/W_{11T}. Other examples include W₁₂/W_{11T}≤ 1, W₁₂/W_{11T}≤1.15, or W₁₂/W_{11T}≤1.3. Widths W_{11T} and W₁₂ are measured perpendicular to the longitudinal axis 14 of the wire 12 and parallel to the plane 32 at the proximal end 21ₚ of the reflective ribs 21.

Cap material can be selected for improved wire grid polarizer performance and improved corrosion resistance of the cap 22. The cap material can be formed from material of the reflective rib 21, material of a mask-layer 62 (see FIG. 6) used for etching the reflective ribs 21, material of the substrate 11, etch gas chemistry, or combinations thereof.

Material of the reflective rib 21, material of the mask-layer 62, or both can be released into the etch chamber, then deposited as part of the cap 22 while etching the polarizing-layer 52 to form the reflective rib 21, as described below. Material of the substrate 11 can be released into the etch chamber, then deposited as part of the cap 22 while etching the substrate to form the substrate ribs 11_{R}.

For example, the cap 22 can include the following chemistry: (a) carbon; (b) a carbon atom bonded to a single oxygen atom with a single bond, such as for example an alcohol or an ether; (c) a carbon atom bonded to a single oxygen atom with a double bond, such as for example carbonyl or aldehyde; (d) a carbon atom bonded to one oxygen atom with a double bond and to another oxygen atom with a single bond, such as for example carboxyl, carboxylate, or ester; (e) aluminum; (f) aluminum fluoride; (g) aluminum oxide; (h) fluorine; (g) oxygen; (h) silicon; or (i) combinations thereof.

The cap 22 can include carbon atoms, each bonded to another carbon atom with a single bond but not bonded to oxygen, in the following atomic percentages: ≥0.1%, ≥0.5%, or ≥2%; and ≤4%, ≤10%, or ≤20%. The cap 22 can include carbon atoms, each bonded to a single oxygen atom with a single bond, in the following atomic percentages: ≥0.1%, ≥0.5%, ≥2%, or ≥4%; and ≤ 5%, ≤10%, or ≤20%. The cap 22 can include carbon atoms, each bonded to a single oxygen atom with a double bond, in the following atomic percentages: >0.1%, ≥0.5%, or ≥1.5%; and ≤3%, ≤6%, ≤10%, or ≤20%. The cap 22 can include carbon atoms, each bonded to one oxygen atom with a single bond and bonded to another oxygen atom with a double bond, in the following atomic percentages: ≥0.05%, ≥0.2%, or ≥0.5%; and ≤1%, ≤5%, or ≤10%.

The cap 22 can include aluminum atoms in the following atomic percentages: ≥5%, ≥10%, or ≥20%; and ≤20%, ≤30%, ≤45%, or ≤60%. These aluminum atoms can be in aluminum fluoride, aluminum oxide, or both. The cap 22 can include fluorine atoms in the following atomic percentages: ≥1%, ≥5%, or ≥10%; and ≤10%, ≤15%, or ≤30%. The cap 22 can include oxygen atoms in the following atomic percentages: ≥10%, ≥15%, or ≥30%; and ≤30%, ≤45%, or ≤60%. The cap 22 can include silicon atoms in the following atomic percentages: ≥0.1%, ≥ %, or ≥5%; and ≤10%, ≤15%, or ≤20%.

A total atomic percent of all elements in the cap 22 is of course 100%.

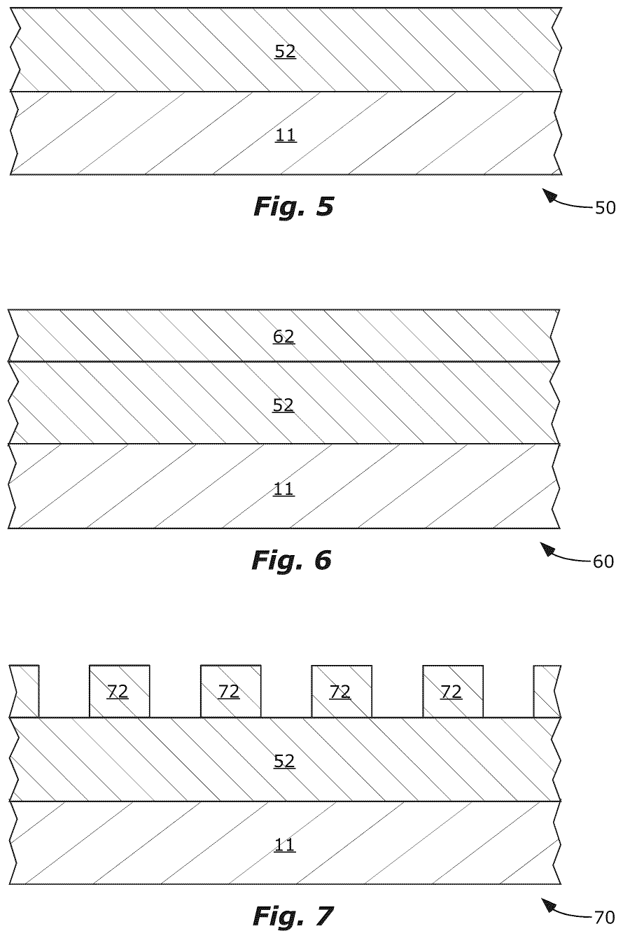

The carbon atoms in the cap 22 can come from the mask-layer 62, from etch gas chemistry, or both (see method section below and FIG. 6). The aluminum atoms in the cap 22 can come from etching the polarizing-layer 52 (see method section below and FIGS. 5-7). The fluorine atoms in the cap 22 can come from etch gas chemistry (see the method section below and FIG. 4). The oxygen atoms and the silicon atoms in the cap 22 can come from the mask-layer 62, from etching the substrate 11 to form the grid of substrate ribs 11_{R}, or both (see the method section below and FIG. 4).

### Method

A method of making a wire grid polarizer with a protective cap 22 can include some or all of the following steps. These steps can be performed in the following order or other order if so specified. Some of the steps can be performed simultaneously unless explicitly noted otherwise in the claims. Components of the wire grid polarizer, and the wire grid polarizer itself, can have properties as described above.

The method can comprise:
step 1: applying a polarizing-layer 52 to a surface of a substrate 11 (see FIG. 5);
step 2: applying a mask-layer 62 on the polarizing-layer 52, the mask-layer 62 including organic moieties (see FIG. 6);
step 3: forming a grid pattern 72 in the mask-layer 62 (see FIG. 7);
step 4: etching the polarizing-layer 52, with the grid pattern 72 as a mask, to form an array of wires 12 in the polarizing-layer 52 and a cap 22 on each wire of the array of wires 12 (see FIGS. 1-3); and
step 5: using the wire grid as a mask to etch a grid of substrate ribs 11_{R} into the substrate 11, each substrate rib 11_{R} aligned with one of the wires 12 of the wire grid (see FIG. 4).

In step 2, the polarizing-layer 52 can be a reflective material.

In step 2, the mask-layer 62 can initially be a liquid with solid nanoparticles dispersed throughout a continuous phase, the nanoparticles including the organic moieties. Example chemistry of the organic moieties includes —CH₃, —CH₂CH₃, —OR, —OCOR, —N(R)₂, or combinations thereof, where R is an alkyl group.

Step 2 can further comprise curing the mask-layer 62 into a solid, interconnecting network of the nanoparticles, prior to using the mask-layer 62 as a mask to etch the polarizing-layer 52. Baking to drive out volatile solvents can be used for curing.

Chemistry of the mask-layer 62 can include tetramethyl orthosilicate, methyltrimethoxysilane, methanol, bis(2-ethoxyethyl) ether, ethyl diglycol, propyl alcohol, tert-butyl alcohol, or combinations thereof.

Step 2 can further comprise:
(a) spin coating an uncured layer onto the polarizing-layer 52 to form part of the mask-layer 62, defining a first spin coat;
(b) baking the mask-layer 62, defining a first bake;
(c) spin coating an uncured layer onto the first spin coat, defining a second spin coat; then
(d) baking the polarizer or coated substrate 11, defining a second bake.

The spin coating and the baking steps can be repeated a third time, a fourth time, or more times. The spin coatings can form the mask-layer 62. Uniformity of the mask-layer 62 can be improved by multiple repeats of these spin coating and baking steps, but cost also increases with each repeat. Therefore, uniformity specifications can be weighed against cost in deciding the number of repeats, if any. Increased uniformity of the mask-layer 62 can improve etching the polarizing-layer 52 and chemistry of the cap 22.

Time of each spin coat depends on desired thickness and on the spin coater. Example times include ≥2 seconds, ≥4 seconds, or ≥6 seconds; and ≤ 10 seconds, ≤20 seconds, or ≤30 seconds for each spin coat.

Examples of speed of the first spin coat, the second spin coat, or additional spin coatings include ≥100 rpm, ≥500 rpm, ≥1000 rpm, or ≥1500 rpm; and ≤2500 rpm, ≤3000 rpm, ≤4000 rpm, or ≤8000 rpm. Examples of temperature of the first bake, the second bake, or other bakes include ≥30° C., ≥ 50° C., ≥100° C., or ≥150° C.; and ≤250° C., ≤300° C., or ≤400° C.

In step 3, example methods of forming the grid pattern 72 include nanoimprint lithography and laser interference lithography. Nanoimprint lithography is preferred because it has resulted in a more durable cap 22 and higher polarizer performance.

In step 4, etch chemistry can include hydrogen bromide to assist in formation of the cap 22. Etching can include flowing the following gases into the etch chamber where the polarizing-layer 52 is etched and the cap 22 is formed: (a) carbon tetrafluoride to form the grid pattern 72 in the mask-layer 62; (b) boron trichloride as an initial etch to form the array of wires 12; (c) argon, nitrogen, and hydrogen bromide as a final etch to form the array of wires 12; then (d) carbon tetrafluoride and oxygen to etch the substrate 11 to form the substrate ribs 11_{R}.

In step 4, reduced flow of etch gases, lower temperature, and lower pressure can help form the cap 22 or increase thickness of the cap 22.

An example etch tool for step 4 is Lam Research Model 2300 Versys Kiyo 45.

The cap 22 can have a material composition as described above the method.

What is claimed is:

1. A wire grid polarizer, comprising:
an array of wires on a substrate with a channel between each pair of adjacent wires;
each wire includes a cap on a reflective rib;
the reflective rib has a distal end farthest from the substrate, a proximal end closest to the substrate, and a pair of sidewalls,
each sidewall faces a channel and extends from the distal end to the proximal end;
the reflective rib is formed of a reflective material extending continuously between the pair of sidewalls and between the distal and proximal ends;
the cap is located on the distal end and the pair of sidewalls; and
the cap includes a carbon-carbon single bond, a carbon-oxygen single bond, a carbon atom bonded to a single oxygen atom with a double bond, another carbon atom bonded to one oxygen atom with a double bond and to another oxygen atom with a single bond, aluminum fluoride, and aluminum oxide;
each reflective rib has a maximum width in a lower 50% of the wire closest to the substrate; and
each cap has a maximum thickness on the sidewall of the reflective rib in an upper 50% of the wire farthest from the substrate.

2. The wire grid polarizer of claim 1, further comprising:
the wire is located on a substrate rib;
the substrate rib is integral with the substrate;
each substrate rib has a base adjoining the substrate and a top adjoining a bottom of the wire;
1.2≤W_{11T}/W_{12B}≤2, where W_{11T} is a width of the top of the substrate rib and W_{12B} is a width of the bottom of the wire, both widths W_{11T} and W_{12B} measured perpendicular to a longitudinal axis of the wire and parallel to a plane at the proximal end of the reflective ribs; and
≤W_{11B}/W_{11T}≤1.4, where W_{11B} is a width of the base of the substrate rib measured perpendicular to the longitudinal axis of the wire and parallel to the plane at the proximal end of the reflective ribs.

3. The wire grid polarizer of claim 1, wherein the cap completely covers the distal end and ≥70% of the sidewalls.

4. A wire grid polarizer, comprising:
an array of wires on a substrate with a channel between each pair of adjacent wires;
each wire includes a cap on a reflective rib;
the reflective rib has a distal end farthest from the substrate, a proximal end closest to the substrate, and a pair of sidewalls;
each sidewall faces a channel and extends from the distal end to the proximal end;
the reflective rib is formed of a reflective material extending continuously between the pair of sidewalls and between the distal and proximal ends;
the cap is located on the distal end and the pair of sidewalls; and
the cap includes carbon.

5. The wire grid polarizer of claim 4, further comprising:
the wire is located on a substrate rib;
the substrate rib is integral with the substrate;
each substrate rib has a base adjoining the substrate and a top adjoining a bottom of the wire;
W_{11T}>W_{12B}, where W_{11T} is a width of the top of the substrate rib and W_{12B} is a width of the bottom of the wire, both widths W_{11T} and W_{12B} measured perpendicular to a longitudinal axis of the wire and parallel to a plane at the proximal end of the reflective ribs.

6. The wire grid polarizer of claim 5, wherein 1.2≤W_{11T}/W_{12B}≤2.

7. The wire grid polarizer of claim 5, wherein 1.1≤W_{11B}/W_{11T}≤1.4, where W_{11B} is a width of the base of the substrate rib measured perpendicular to the longitudinal axis of the wire and parallel to the plane at the proximal end of the reflective ribs.

8. The wire grid polarizer of claim 5, wherein 1.2≤W_{11T}/W_{12B}≤2.

9. The wire grid polarizer of claim 5, wherein 0.85≤W₁₂/W_{11T}≤1.15, where W₁₂ is a maximum width of the wire measured perpendicular to the longitudinal axis of the wire and parallel to the plane at the proximal end of the reflective ribs.

10. The wire grid polarizer of claim 4, wherein each cap is separated from caps of adjacent wires by the channels.

11. The wire grid polarizer of claim 4, wherein 1≤W_{R}/Th_{CS}≤3, where:
W_{R} is a maximum width of the reflective rib and Th_{CS} is a maximum thickness of the cap on the sidewall;
both the maximum width W_{R} and the maximum thickness Th_{CS} measured on a single wire, measured perpendicular to a longitudinal axis of the wire, and measured parallel to a plane at the proximal end of the reflective ribs.

12. The wire grid polarizer of claim 4, wherein 1.5≤Th_{CS}/Th_{CD}≤4, where:
Th_{CS} is a maximum thickness of the cap on the sidewall and Th_{CD} is a maximum thickness of the cap on the distal end;
both the maximum thicknesses Th_{CS} and Th_{CD} are measured on a single wire and measured perpendicular to a longitudinal axis of the wire; and
the maximum thickness Th_{CS} of the cap on the sidewall is measured parallel to a plane at the proximal end of the reflective ribs; and
the maximum thickness Th_{CD} of the cap on the distal end is measured perpendicular to the plane at the proximal end of the reflective ribs.

13. The wire grid polarizer of claim 4, wherein:
each reflective rib has a maximum width in a lower 50% of the wire closest to the substrate; and
each cap has a maximum thickness on the sidewall of the reflective rib in an upper 50% of the wire farthest from the substrate.

14. The wire grid polarizer of claim 4, wherein the cap completely covers the distal end and ≥70% of the sidewalls.

15. The wire grid polarizer of claim 4, wherein the cap further comprises:
a carbon-carbon single bond;
a carbon-oxygen single bond;
a carbon atom bonded to a single oxygen atom with a double bond; and
another carbon atom bonded to one oxygen atom with a double bond and to another oxygen atom with a single bond.

16. The wire grid polarizer of claim 4, wherein the cap further comprises aluminum, oxygen, and fluorine.

17. The wire grid polarizer of claim 4, wherein the cap further comprises aluminum fluoride and aluminum oxide.

18. The wire grid polarizer of claim 4, wherein the cap further comprises:
0.5 atomic percent to 10 atomic percent of atoms in the cap are carbon atoms, each bonded to another carbon atom with a single bond and which is not bonded to oxygen;
0.5 atomic percent to 10 atomic percent of atoms in the cap are carbon atoms, each bonded to a single oxygen atom with a single bond;
0.5 atomic percent to 10 atomic percent of atoms in the cap are carbon atoms, each bonded to a single oxygen atom with a double bond;
0.5 atomic percent to 10 atomic percent of atoms in the cap are carbon atoms, each bonded to one oxygen atom with a single bond and bonded to another oxygen atom with a double bond;
10 atomic percent to 45 atomic percent of atoms in the cap are aluminum atoms;
one atomic percent to 15 atomic percent of atoms in the cap are fluorine atoms; and
20 atomic percent to 60 atomic percent of atoms in the cap are aluminum atoms.

19. A method of making a wire grid polarizer with a protective cap, the method comprising:
applying a polarizing-layer to a surface of a substrate;
applying a mask-layer on the polarizing-layer, the mask-layer including organic moieties;
forming a grid pattern in the mask-layer; and
etching the polarizing-layer with etch chemistry including hydrogen bromide, with the grid pattern as a mask, to form an array of wires in the polarizing-layer and a cap on each wire, the cap including carbon;
wherein each wire is formed of a reflective material extending continuously between a pair of sidewalls and between distal and proximal ends of each wire.

20. The method of claim 19, wherein the cap further comprises the following organic moieties:
a carbon atom bonded to an oxygen atom with a single bond;
a carbon atom bonded to a single oxygen atom with a double bond; and
a carbon atom bonded to one oxygen atom with a double bond and to another oxygen atom with a single bond.
